(19) United States
(12) Patent Application Publication
(10) Pub. No.: US 2025/0086638 A1
(43) Pub. Date: Mar. 13, 2025

(54) SYSTEMS AND METHODS FOR ANOMALY DETECTION USING EXPLAINABLE MACHINE LEARNING ALGORITHMS

(71) Applicant: Hawk AI GmbH, Munich (DE)

(72) Inventor: Felix Berkhahn, Munich (DE)

(21) Appl. No.: 18/903,693

(22) Filed: Oct. 1, 2024

Related U.S. Application Data
(63) Continuation of application No. PCT/EP2023/060861, filed on Apr. 25, 2023.
(60) Provisional application No. 63/334,324, filed on Apr. 25, 2022.

(51) Int. Cl. G06Q 20/40; G06N 5/01; G06N 5/045

(52) U.S. Cl. CPC G06Q 20/4016; G06N 5/01; G06N 5/045

(57) ABSTRACT

The platforms, systems and methods provided herein may provide explanations for AI algorithm outputs to facilitate efficiency and trust for a user. More specifically, the platforms, systems and methods provided herein may provide anomaly detection using explainable machine learning algorithms. Provided here is a computer-implemented method for providing explanations for AI algorithm outputs, comprising: (a) receiving transaction log data; (b) identifying anomalous transactions based at least in part on the transaction log data; (c) generating an expectation surface for one or more anomalous transactions; and (d) generating explanations for the anomalous transactions based at least in part on the expectation surface.

### CROSS-REFERENCE TO RELATED APPLICATIONS

This application is a continuation of International Application No. PCT/EP2023/060861, filed on Apr. 25, 2023, which claims the priority and benefit of U.S. Provisional Application No. 63/334,324, filed on Apr. 25, 2022, the entirety of which is incorporated herein by reference.

### BACKGROUND

There has been a surge in the use of Machine Learning (ML) algorithms in automating various facets of science, business, and social workflow. While Artificial intelligence (AI) systems are developed and built to make decisions autonomously without prescribed rules, the large number of parameters in models such as such as Deep Neural Networks (DNNs) make them complex to understand and undeniably harder to interpret. Systems whose decisions cannot be well-interpreted are difficult to be trusted, especially in sectors, such as finance, banking, healthcare, and the like.

AI systems have been utilized for anomaly detection which has wide applications across industries. For instance, in Internet of Things (IoT) industry, AI systems has been utilized to detect anomalies in the individual IoT devices and/or the interconnections between the IoT devices; these anomalies may comprise device failure, overheat, abnormal energy consumption, security breaches, etc. In the cybersecurity industry, AI systems have been utilized to detect anomalies in network traffic, user behavior, and software applications; these anomalies may comprise malware, intrusions, phishing attaches, insider threats, etc. In the telecommunications industry, AI systems have been utilized to detect anomalies in network traffic, customer behavior, and network infrastructure, among other areas. These anomalies may comprise network congestion, network failures, fraudulent activity, station failure, etc. In the industrial facilities industry, AI systems have been utilized to detect anomalies in production lines, equipment performance, and worker safety, among other areas. In healthcare, AI systems have been utilized to detect fraudulent insurance claims and payments, and in finance, AI systems have been utilized to find pattern of fraudulent purchases. In banking field, AI systems can be utilized to detect financial crimes such as money laundering activity which is an outlier to certain patterns of depositing money into account holder's account. Money laundering is the process of changing large amounts of money obtained from crimes, such as drug trafficking, into origination from a legitimate source. It is a crime in many jurisdictions. Financial institutions and other regulated entities have set anti-money laundering (AML) regimes to prevent, detect, and report money laundering activities. An effective AML program requires financial institutions to be equipped with tools to investigate, to identify their customers, establish risk-based controls, keep records, and report suspicious activities. In recent years, machine learning-based transaction monitoring systems have been successfully used to complement traditional rule-based systems. This is done to reduce the high number of false positives and the effort needed to manually review all the generated alerts.

### SUMMARY

Using artificial intelligence (AI) to aid in anomaly detection such as IoT system and/or device failures and/or malfunctions, suspicious data packets in network traffic, equipment failures, or Anti-money laundering (AML) detection may provide a number of advantages comparing to traditional AML system, such as better implementation, reduced administrative complexity and false positives, etc. However, in certain industry or fields, in addition to anomaly detection, it is also desirable to provide explanation about what contributed to a detected anomaly for increasing reliability and trust in the AI system. For example, in the field of financial industry, especially in AML, an explainable AI is desirable due to, without limitation, regulatory reasons (e.g., the authority would want to know what the suspicious activities are, and why an activity is suspicious). Providing a human-comprehensible explanation may also enable financial investigators to ascertain the attributes, severity, and tendencies of the suspicious activities quickly and take actions accordingly.

Conventional AI algorithms used in the AML regimes may provide predictions/detections of suspicious activities. However, these conventional AI algorithms do not provide sufficient explanations to the output indicative of the predictions of suspicious activities. This may cause the information receivers, (e.g., tech experts, maintenance team, hardware and software engineers, investigators, regulators, and law enforcement people, etc.) to be skeptical about the output provided by these AL algorithms. Therefore, the value conveyed by these AI algorithms may be reduced or diminished because of the reasonable skepticism from the investigators and regulators.

The field of explainable AI is focused on the understanding and interpretation of the behavior of AI systems. However, current explainable AI techniques may not be capable of providing sufficient explanation. For instance, current explainable AI models may provide interpretability which is mostly connected with the intuition behind the outputs of a model; with the idea being that the more interpretable a machine learning system is, the easier it is to identify cause-and-effect relationships within the system's inputs and outputs. However, such interpretable model may not translate to one that humans are able to understand the internal logic of or its underlying processes. For instance, current interpretable models may only be able to provide what features contribute to a detection of suspicious activities, i.e., using credit allocation with local explanations. They do not provide the reason(s) why this/these feature(s) have led to the detection of suspicious activities. For example, some conventional methods, such as SHapley Additive explanations (SHAP) explanations may provide a certain degree of explanations of the output of an AL algorithm. SHAP is a game theoretic approach to explain the output of machine learning (ML) model. It may connect optimal credit allocation with local explanations using the classic Shapley values from game theory and their related extensions. However, these explanations may only provide what features contribute to a detection of suspicious activities, i.e., using credit allocation with local explanations. They do not provide the reason(s) why this/these feature(s) have led to the detection of suspicious activities. In a way, it is similar to providing medical lab results without providing a reference range for the vital signs, and the investigators and regulators would not have put trust in these incomplete explanations.

This problem intensifies with the complexities of traits of the financial activities in different business, industries, countries, i.e., there is no universal reference ranges for all financial activities. The reference range depends largely on the industry, business model, and other factors. Financial datasets often consist of high-dimensional feature spaces that are difficult to inspect. Being an outlier does not necessarily imply that a particular application is fraudulent. Thus, it is crucial to be able not only to evaluate an instance given its anomaly score but also to understand the drivers behind the model decision. Therefore, a sophisticated human-comprehensible explanation along with the AL algorithms are desired in the financial industry.

Recognized herein is the need to provide highly sophisticated explanations of results/outputs of AI algorithms in AML programs. The explanations may not only provide what features led to an anomaly (i.e., a detection of suspicious activities), but may also provide the reason(s) why these features have led to the anomaly. Unlike conventional explainable AI methods such as SHAP explanations, methods and systems herein may provide a unique local feature importance algorithm (e.g., Expectation Surface) that not only return what features contributed to the anomalousness of a datapoint, but they additionally convey what the expected value range of a feature would have been, leading to improved explainability.

In some embodiments, the improved explanation may be based on an expected value range of a feature would have been that is generated by the local feature importance algorithm (e.g., Expectation Surface). The Expectation Surfaces may be capable of taking higher dimensional correlation of features into account without compromising computational efficiency of the algorithm. In some embodiments, the methods herein may provide a novel local feature importance algorithm for an anomaly detection model such as Isolation Forest (iForest) model. Such methods may be implemented in various applications such as cybersecurity software, factory management system, IoT system and devices mapping and management mechanism, Transaction Monitoring software, Anti-Money-Laundering mechanism, and other crime or fraudulent detection systems. For example, an expected value or value range, by means of an expectation surface(s), is provided in the context of a particular data packet of the network traffic, a group of data packets, a certain type of data packet, etc. Additionally, the methods and systems herein may be capable of providing improved explanations with sufficient accuracy and robustness for anomaly detection.

The present disclosure provides a computer-implemented method for providing explanations for AI algorithm outputs. The method comprises: (a) receiving transaction log data; (b) identifying anomalous transactions based at least in part on the transaction log data; (c) generating an expectation surface for one or more anomalous transactions; and (d) generating explanations for the anomalous transactions based at least in part on the expectation surface.

The system/method described above can provide sophisticated explanations to the output of AI algorithms. By structuring the algorithms to provide expectation surface, the methods and systems described herein also provide expected value or value range for one or more features. The expected value may provide information receivers, (e.g., investigators, regulators, and law enforcement people, etc.) with insights why these transactions are marked anomalous, so as to facilitate investigation activities. Additionally, the algorithms herein are structured to provide improved algorithmic complexities, runtime performance and memory efficiency. Although the method and system are described in the context of detecting money laundering, risk behavior analysis, it should be noted that methods and systems herein can be utilized in a wide range of fields that may involve any type of anomaly detection, risk assessment, behavior analytics and the like.

In an aspect, a computer-implemented method for providing explainable anomaly detection is provided. The method comprises; (a) generating a set of input features by processing an input data packet related to one or more transactions; (b) predicting, using a model trained using a machine learning algorithm, an anomaly score for each of the one or more transactions by processing the set of input features; (c) computing an expectation surface for at least subset of features from the set of input features; and (d) generating, based at least in part on the expectation surface, an output comprising i) a detection of an anomalous transaction from the one or more transactions, ii) one or more factors attributed to the anomalous transaction and iii) an expected value range for the one or more factors.

In some embodiments, the model does not provide explanation of a prediction and wherein the machine learning algorithm is unsupervised learning. In some embodiments, the model is an isolation forest model. In some cases, the expectation surface is a one-dimensional surface and wherein the expectation surface is computed by traversing a tree of the isolation forest model. Alternatively, the expectation surface is a surface of n dimensionality and wherein the expectation surface is computed by distinguishing an actual path from an exploration path. In some instances, the exploration path allows n features to vary at the same time.

In some embodiments, the expectation surface has a dimensionality same as the number of the subset of features. In some embodiments, the expectation surface is an inverted anomaly score surface of the subset of features. In some cases, the at least subset of features is selected using a local feature importance algorithm.

In some embodiments, the anomalous transaction is a fraudulent activity. In some cases, the method further comprises comparing the expectation surface with one or more expectation surfaces of one or more other types of business. In some cases, the method further comprises determining a money laundering activity upon finding a match of the expectation surface with the one or more expectation surfaces.

In another related yet separate aspect, a system for providing explainable anomaly detection is provided. The system comprises a first module comprising a model trained to predict an anomaly score for each of one or more transactions, where an input to the model includes a set of input features related to the one or more transactions; a second module configured to compute an expectation surface for at least a subset of features from the set of input features, and a graphical user interface (GUI) configured to display information based at least in part on the expectation surface, i) a detection of an anomalous transaction from the one or more transactions, ii) one or more factors attributed to the anomalous transaction and iii) an expected value range for the one or more factors.

In some embodiments, the model does not provide explanation of a prediction and is trained using unsupervised learning. In some embodiments, the model is an isolation forest model. In some cases, the expectation surface is a one-dimensional surface and wherein the expectation surface is computed by traversing a tree of the isolation forest model. In some cases, the expectation surface is a surface of n dimensionality and wherein the expectation surface is computed by distinguishing an actual path from an exploration path. In some instances, the exploration path allows n features to vary at the same time.

In some embodiments, the expectation surface has a dimensionality same as the number of the subset of feature. In some embodiments, the expectation surface is an inverted anomaly score surface of the subset of features. In some embodiments, the subset of features is selected using a local feature importance algorithm.

In some embodiments, the anomalous transaction is a fraudulent activity. In some embodiments, the expectation surface is compared against one or more expectation surfaces of one or more other types of business to determine the fraudulent activity.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates a block diagram depicting an example system, according to embodiments of the present disclosure, comprising a client-server architecture and network configured to perform the various methods described herein.

FIG. 2 illustrates an example tree structure, according to embodiments of the present disclosure.

FIG. 3A illustrates an expectation surface for business type 1 and a set of transaction data points, according to one embodiment.

FIG. 3B illustrates an expectation surface for business type 1 and an expectation surface for business type 2, and a set of transaction data points, according to one embodiment.

FIG. 3C shows an example of an output of the system utilizing expectation surfaces.

FIG. 4 is a flow diagram depicting an example process for providing explanations for outputs of an AI algorithm for financial transactions, according to one embodiment.

FIG. 5 shows a computer system that is programmed or otherwise configured to implement methods provided herein.

FIGS. 6-9 show various examples of GUI provided by the methods and systems herein for fraud detection and transaction monitoring.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As mentioned above, current AI solutions for detecting anomalies may have disadvantages: unsupervised models lead to low performance, resulting in a high number of false positives, while supervised models require a large amount of labeled data to achieve a high detection rate. For instance, labels are expensive to obtain and often require substantial human labor. Additionally, not all states a detection system could take on are known in advance. Instead, the use case often requires generally the detection of states outside the ordinary operation. In all these scenarios, anomaly detection techniques are paramount. Anomaly detection models such as Isolation Forest (iForest) model, though provides robustness, simplicity and accuracy, the model itself lacks capability of interpretation or explanation. While reliable approaches to compute local feature importance exist for the iForest, such as SHAP explanations or DIFFI, they don't provide any information about the expected value of a feature. In other words, the model conveys what features led to an anomaly, but not why. Current solutions lack the capability of providing feedback about what a normal value of a feature would have been.

Providing the expected value of a feature can be challenging because the expected value can depend on the values of other features, even if they are not assigned a high local feature importance score. The algorithms and methods provided herein may be capable of providing the explanation including why certain features led to an anomaly may take into account potential correlation and interdependencies of features. Details about the algorithm and methods are described later herein.

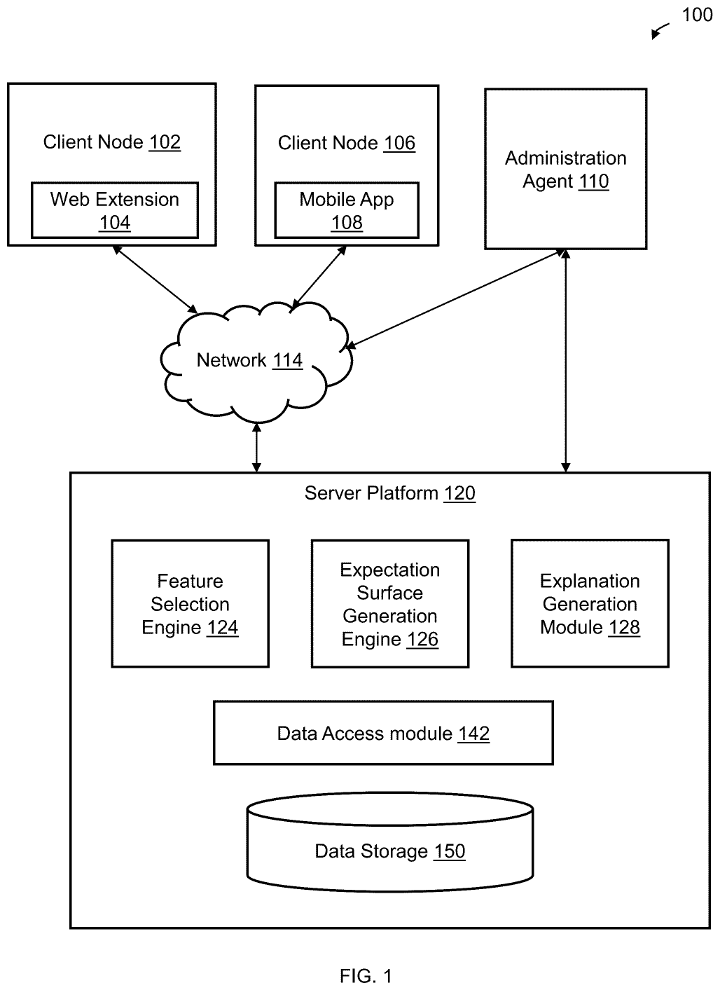

FIG. 1 illustrates a block diagram depicting an example environment 100, in which systems and methods according to embodiments of the present disclosure can be implemented. In some embodiments, the environment may comprise a client-server architecture and network configured to perform the various methods described herein. A platform (e.g., machines and software, possibly interoperating via a series of network connections, protocols, application-level interfaces, and so on), may be in the form of a system (e.g., server platform 120), providing server-side functionality via a communication network 114 (e.g., the Internet or other types of wide-area networks (WANs), such as wireless networks or private networks with additional security appropriate to tasks performed by a user) to one or more client nodes 102, 106, and/or administration (admin) agent 110. FIG. 1 illustrates, for example, a client node 102 hosting a web extension 104, thus allowing a user to access functions provided by the system (e.g., server platform 120), for example, receiving an output of an AI algorithm from the server platform 120. The web extension 104 may be compatible with any web browser application used by a user of the client node. Further, FIG. 1 illustrates, for example, another client node 106 hosting a mobile application 108, thus allowing a user to access functions provide by the server platform 120, for example, receiving an output of an AI algorithm from the server platform 120. Delivery of the output of an AI algorithm may be through a wired or wireless mode of communication. The output of an AI algorithm may comprise, without limitation, an indication of a detected event, an explanation what features contribute to the detection, and/or an explanation of the reasons one or more features contribute to the detection.

A client node (e.g., client node 102 and/or client node 106) may be, for example, a user device (e.g., mobile electronic device, stationary electronic device, etc.). A client node may be associated with, and/or be accessible to, a user. In another example, a client node may be a computing device (e.g., server) accessible to, and/or associated with, an individual or entity. A client node may comprise a network module (e.g., network adaptor) configured to transmit and/or receive data. Via the nodes in the computer network, multiple users and/or servers may communicate and exchange data, such as financial transaction logs, outputs of AI algorithms, etc. In some instance, the client nodes may transmit information associated with a set of financial transaction logs to the server platform 120. Examples of the information associated with financial transaction logs include, without limitation, transaction amount, transaction currency (e.g., U.S. Dollar, Euro, Japanese Yen, Great British Pound, Australian Dollar, Canadian Dollar, etc.), transaction type name (e.g., wire activities, cash deposit activities, regular check, cashier's check, certified check, money order, etc.), transaction time (e.g., time of a day, day of a year/a quarter, etc.), transaction unique identification number, and the like. In some embodiments, the client nodes may receive and present to a user an Internet-featured item (e.g., an explanation table).

In at least some examples, the system (e.g., server platform 120) may be one or more computing devices or systems, storage devices, and other components that include, or facilitate the operation of, various execution modules depicted in FIG. 1. These modules may include, for example, a feature selection engine 124, an expectation surface generation engine 126, an explanation generation module 128, a data access modules 142, and a data storage 150. Each of these modules is described in greater detail below. In alternative embodiments, the system may not require a feature selection engine. For instance, the expectation surface (e.g., one dimensional expectation surface) can be computed for all features without the need of applying a feature selection algorithm.

The feature selection engine 124 may be configured to receive a stream of data such as data representing network traffic (e.g., traffic logs), data representing IoT devices' connectivity and/or general health, data representing production line productivities, data representing financial transactions (e.g., financial transaction logs). The features selection engine 124 may implement a feature selection algorithm for selecting features to calculate expectation surface. In some embodiments, features are selected when the model was trained. For example, during model run time, the feature selection engine 124 may query the database storing historic transactions selecting the same features to calculate expectation surface. In some embodiments, the feature selection engine 124 may query database storing historic data (e.g., historic network traffic logs and features associated with the logs, historic IoT devices' connectivity, historic transactions) to select features to calculate expectation surface based on pre-determined rules. Historic network traffic logs may comprise source and destination IP addresses, protocols and ports, packet size and volume, timestamps, etc. In some embodiments, to detect anomalies, data representing IoT devices' connectivity and/or general health may comprise device status, data traffic, energy consumption, sensor data, etc. In some embodiments, financial transaction logs data may comprise, without limitation, transaction amount, transaction currency (e.g., U.S. Dollar, Euro, Japanese Yen, Great British Pound, Australian Dollar, Canadian Dollar, etc.), transaction type name (e.g., wire activities, cash deposit activities, regular check, cashier's check, certified check, money order, etc.), transaction time (e.g., time of a day, day of a year/a quarter, etc.), transaction unique identification number, and the like. It should be noted that although algorithms and methods herein are described with respect to transactional data or Anti-money laundering (AML) monitoring, they can be applied in various scenarios where anomaly detection and explanations are desired. For example, the methods and systems herein can be applied to industries and applications such as finance, banking, healthcare, and various other fraudulent crime detection or anomaly detection.

In the cases when the methods and systems herein are utilized in transaction monitoring, the transactions may be monitored and assigned with a risk score in real-time by the system. The risk score may correspond to a money-laundering risk level (e.g., money-laundering risk score). The term “risk score” may also be referred to as “anomaly score” which are utilized interchangeably throughout this specification. In some embodiments, this money-laundering risk score may be generated by Isolation Forest (IForest) model. In some embodiment, this money-laundering risk score may be generated based on the financial transaction data associated with financial transaction logs. For example, the further a transaction (or a group of transactions) does not conform to the normal profile, the higher a risk score may be associated to the transaction. In some embodiments, a risk score is assigned to a group of financial transactions associated with one entity, e.g., a bakery, a restaurant, a bookstore, a car dealer etc. In some embodiments, a risk score is assigned to a group of financial transactions associated with one entity during a period of time, e.g., an hour, a few hours, a day, a week, two weeks, three weeks, a month, a quarter, a year, a few years, etc. As described elsewhere herein, a risk score may denote an outlier that does not conform to the normal profile of the transaction in context of the industry the transaction is in. A pre-determined threshold is used to filter out transactions anomalous based on the risk score and may mark the underlying transaction(s) as an anomaly. In some embodiments, this pre-determined threshold may be determined by an administration agent, such as the administration agent 110. In some embodiments, this pre-determined threshold may be determined by a Machine Learning model, which has been trained to understand the normal profile in different industries or for different business models. Examples of different industries may comprise, without limitation, restaurants, car dealers, bookstores, software companies, etc. Examples of business models may comprise, without limitation, retailers, distributions, wholesales, manufactures, designer, service providers, etc.

The system herein may comprise a dynamic network of a plurality of AI engines (e.g., anomaly detection AI engine, payment screening AI engine, transaction monitoring AI engine, etc.) acting in parallel, which consistently act and react to other engine's action at any given time and/or over time, which actions may be based on detected, inter-relational dynamics as well as other factors leading to more effective actionable value. The system 100 may provide alignment, coordination and convergence of AI outputs for purposes of generating desired converged optimal outcomes and results. In some embodiments, the one or more AI engines may be deployed using a cloud-computing resource which can be a physical or virtual computing resource (e.g., virtual machine).

The feature selection engine 124 may be configured to select features to calculate an expectation surface based on feature properties associated with individual features of the anomalous transactions. In some embodiments, the features selection engine 124 may select features to calculate the expectation surface for all transactions, whether anomalous or not. Due to correlations between features fₑₛ and features [symbol] . the expected value of a given feature f₁ can depend largely on the choice of other features [symbol] .

In some embodiments, the feature selection engine may take into account the correlation and interdependencies of features by sorting the features by importance and omitting features that have a small effect on the value of the anomaly score. In some cases, the feature selection engine may choose at least a subset of features (e.g., 2-5 most important features) as the most important features according to a suitable local feature importance algorithm. For example, the local feature importance algorithm may compute the SHapley Additive explanations (SHAP) value and select a subset of the important features and/or the subset complementing features [symbol] (to be omitted) accordingly. In some embodiments, the feature selection engine 124 may select a set of other features [symbol] based on feature properties associated with individual features. Feature properties, for example, may comprise local feature importance associated with other features [symbol] . In some embodiments, users may be given an option to select the features that they see fit for the expectation surface that they want to visualize, interact with. In other words, the expectation surface may be computed in an on-demand manner.

The expectation surface generation engine 126 may be configured to generate an expectation surface for the selected subset of features. In some cases, the expectation surface can be computed for all the features. As described above, the subset of features may be the most important for the anomaly score capturing most effects originating from correlations among the input features (e.g., high-dimensional transaction data and/or customer data). The expectation surface may be computed for the input features indicating the expected ranges (that are considered as normal). In some embodiments, the expectation surface generation engine 126 generates an expectation surface to generate explanation for marking the anomalous transactions. In some embodiments, the expectation surface generation engine 126 generates an expectation surface for all received transactions, whether anomalous or not.

In some cases, for a set of input features, e.g., k input features f, an expectation surface may be defined as an inverted anomaly score surface of a selected subset of features, e.g., feature fₑₛ. In some cases, the selected subset of features may be a subset of/features fes={fj: j E {1, 2, . . . , k}}, |fes|=1. The subset of features may be selected by the features selection engine as described above. Details about the algorithm implementing the expectation surface computation and feature selection are described elsewhere herein.

As described elsewhere herein, due to correlations between features fₑₛ and features [symbol] . the expected value of a given feature fᵢ can depend largely on the choice of other features [symbol] . The expectation surface generation engine 126 may calculate the expectation surface based on the selected other features [symbol] , which are selected by the feature selection engine 124. Details of the algorithm implementing the expectation surface method, computation of expectation surface, equations, algorithms are described elsewhere herein.

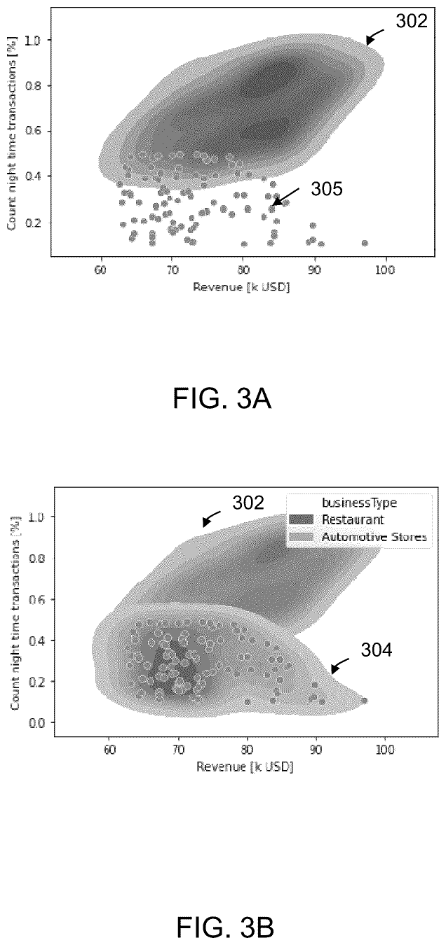

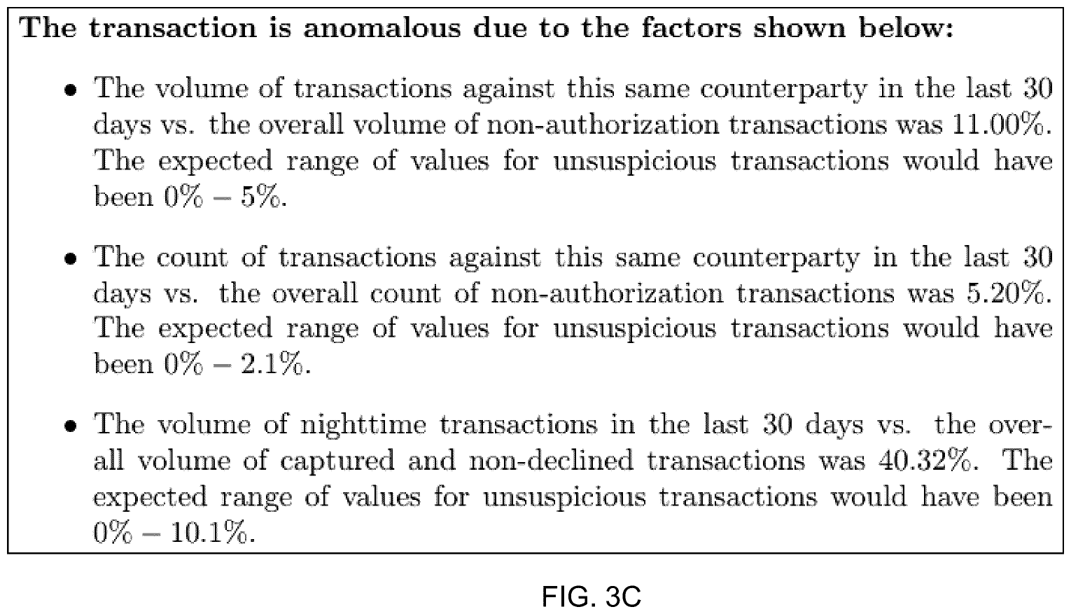

An expectation surface may indicate the normal profile associated with a transaction or a group of transactions. For example, as shown in connection with FIG. 3a and FIG. 3b, an expectation surface may indicate the normal profile associated with transactions in restaurant industry or in an automotive store industry. In some embodiments, the expectation surface may be closely related to the type of business from which the transaction is originated. Examples of different industries may comprise, without limitation, restaurants, car dealers, bookstores, software companies, etc. Examples of business models may comprise, without limitation, retailers, distributions, wholesales, manufactures, designer, service providers, etc. Transactions in different types of business may have different expected ranges that are considered as normal. For example, for a car dealer, the transaction amount may be a relative high number as cars generally are priced higher than a thousand dollars. The transaction frequency for a car dealer, though, may be lower than a grocery store. These traits may be shown by the expectation surface associated with a particular type of business and may be utilized to identify the reasons and explanations as to why some transactions are marked as outliers or anomaly.

The explanation generation module 128 may be configured to generate explanations for the anomalous transactions based at least in part on the expectation surface. In some embodiments, the expectation surface may provide an expected range for difference features or factors. For example, the expectation surface may indicate: for a bakery store, it is normal to have 68-85% revenue generated during morning hours, such as between 6:00 AM to 11:00 AM. When a large number of transactions (e.g., 90%) for a bakery fall outside of this expected range provided by the expectation surface, the transactions may be marked as anomaly. In some embodiments, the explanation generation module 128 may utilize this expectation surface to provide explanations as to the reasons a transaction or a group of transactions are anomalous. For example, for the above example, the explanation generation module 128 may provide explanations such as: 90% of the transactions occurs outside of the expected time period of 6:00 AM to 11:00 AM. In another example explanation, the explanation generation module 128 may provide explanations such as: only 10% of the transactions occurs outside of the expected time period 6:00 AM to 11:00 AM, normally, it should be 68-85%. This may provide the information receivers, (e.g., investigators, regulators, and law enforcement people, etc.) with insights why these transactions are marked anomalous, so as to facilitate investigation activities.

In some embodiments, the explanation generation module 128 may utilize natural language processing (NLP) to generate human-comprehensible explanations. NLP may be a subfield of linguistics, computer science, and artificial intelligence concerned with the interactions between computers and human language. Other mechanisms may be utilized by explanation generation module 128 to generate human-comprehensible explanations.

Data access modules 142 may facilitate access to data storage 150 of the server platform 120 by any of the remaining modules 124, 126, and 128 of the server platform 120. In one example, one or more of the data access modules 142 may be database access modules, or may be any kind of data access module capable of storing data to, and/or retrieving data from, the data storage 150 according to the needs of the particular module 124, 126, and 128 employing the data access modules 142 to access the data storage 150. Examples of the data storage 150 include, but are not limited to, one or more data storage components, such as magnetic disk drives, optical disk drives, solid state disk (SSD) drives, and other forms of nonvolatile and volatile memory components.

As shown in FIG. 1, admin agent 110 may be coupled directly to the system (e.g., server platform 120), thus circumventing the network 114. For example, the admin agent 110 may be co-located with the server platform 120, coupled thereto via a local network interface. In another example, the admin agent 110 may communicate with the server platform 120 via a private or public network system, such as the network 114.

At least some of the embodiments described herein with respect to the system 100 of FIG. 1 provide various techniques for generating, and delivering to client nodes, explanations for output of AI algorithms which are engageable, by user input, user activity, and/or user response. For example, the explanations for output of AI algorithms shown in FIGS. 3a and 3b may be engageable by user activity such as using a cursor to change the selection on X axis or Y axis. In some embodiments, the system 100 of FIG. 1 provides various techniques for providing explanations if the transaction is identified to suspicious (e.g., above a pre-determined threshold). An expected value or value range, by means of an expectation surface(s) is provided in the context of a particular transaction, a group of transactions, a certain type of transactions, etc. The explanations provided herein will not only provide what features led to an anomaly (i.e., a detection of suspicious activities), but may also provide the reason(s) why these features have led to the anomaly. This may facilitate efficiency, trust, and precludes regulatory impediments.

In the context of cybersecurity, the risk score and expectation surface (expected range for a feature) can be utilized to identify anomalies or potential threats in network traffic, system logs, or other cybersecurity data, and provide reasons why an event is determined to be an anomaly. The risk score can be assigned to different events or activities within the network or system, and events with high risk scores may be flagged for further investigation. In some embodiments, the expectation surface can be utilized to identify features or characteristics of network traffic or system logs that are outside of the expected range, which could indicate a potential security threat or anomaly. By identifying the normal range of features or characteristics, the expectation surface can help to identify unusual or suspicious activity that may require further investigation. For example, in network intrusion detection, the risk score and expectation surface can be used to identify potential attacks or intrusions by analyzing network traffic patterns and identifying events with high risk scores or features outside of the expected range. Similarly, in log analysis, the risk score and expectation surface can be used to identify potential security breaches or anomalies by analyzing system logs and identifying events with high risk scores or features outside of the expected range, along with the expected range, for presentation to a user. In particular, unlike conventional anomaly detection method that requires known known pattern of normal events or normal range of value, the expectation surface herein beneficially allows for interpreting or explaining an anomalous event without knowing the normal range of value (e.g., crime pattern) in advance.

### Expectation Surface

In some embodiments, the anomaly detection algorithm herein may utilize Isolation forest (IForest) to detect anomalies using isolation (e.g., how far a data point is to the rest of the data). The anomaly detection algorithm may isolate anomalies using binary trees with logarithmic time complexity with a generally low constant and a low memory requirement. An anomaly (i.e., outlier) is an observation or event that deviates from other events to arouse suspicion regarding its legitimacy. By focusing on detecting anomalies instead of modeling the normal points, IForest model may provide functions and utilities of detecting suspicious activities, such as for a financial institution. However, the IForest model itself lacks capability of interpretation or explanation. While approaches to compute local feature importance exist for the iForest, such as SHAP explanations or DIFFI, they don't provide any information about the expected value of a feature. In other words, the model conveys what features led to an anomaly, but not why.

Methods and systems herein provide an expectation surface for the IForest model which beneficially generating sophisticated explanations of the output of an IForest model. An expectation surface may be defined herein as an inverted anomaly score surface of a given feature, e.g., feature fₑₛ of dimension l. The below equation (equation 1) may illustrate an expectation surface(ES) of dimensionality of l:

$$ES ( {f}_{e s} ∨ ) = - s ( {f}_{1} , … , {f}_{k} ) + \begin{matrix}maxs ( f ) \\ f\end{matrix} \qquad ( 1 )$$

As equation 1 shows, the expectation surface may be an inverted anomaly score surface of features fₑₛ, assuming that all other features [symbol] are kept constant. In equation 1, (f₁, . . . , fₖ)=s (f) may be the anomaly score of an IForest model for the k input features f. Consider an arbitrary subset of l features fes={fj: j ∈ {1, 2, . . . , k}}, |fes|=l. The complement of fes is denoted [symbol] , [symbol] k−l. The dimensionality of the Expectation surface may be l(l=1, 2, 3, 4, 5, 6, etc.) depending on the selection of the subset of the features. In some embodiments, max_{fes}(ES) may denote or represent the minimal anomaly score for the feature set fₑₛ and hence represents the models' most expected values of these features. The one dimensional expectation surfaces can be computed for all features without the need of applying a feature selection algorithm.

Due to correlations between features fₑₛ and features [symbol] . the expected value of a given feature fᵢ can depend largely on the choice of other features [symbol] . The expectation surface method herein beneficially takes into account potential correlation and interdependencies of features. In some embodiments of implementing the method, the feature selection engine 124 of the system 120 may select a subset of features fₑₛ and/or the complementing features [symbol] based on the importance and/or feature properties associated with individual features, respectively. For instance, the feature selection engine may choose the subset of features (e.g., 2-5 most important features) as the most important features according to a suitable local feature importance algorithm. For example, the local feature importance algorithm may compute the SHapley Additive explanations (SHAP) value and select a subset of the important features and/or the subset complementing features [symbol] (to be omitted) accordingly.

In some embodiments, the feature selection engine 124 may select a set of other features [symbol] based on feature properties associated with individual features. Feature properties, for example, may comprise local feature importance associated with other features [symbol] . In some embodiments, the feature selection engine 124 may sort individual other features [symbol] based on their local feature importance, and the choose the ones above a pre-determined threshold. This may reduce or eliminate the correlation effects of other features [symbol] on the expectation surface of the feature fₑₛ because the local importance score may represent the correlation between the feature fₑₛ and other features [symbol] . An equation (equation 2) below may provide the reason for this effect.

$$∅ {f}_{i} = {\sum }_{S ⊆ \{ {f}_{1} , … , {f}_{i - 1} , f + 1 … {f}_{k} \}} \frac{\vert S \vert ! ( k - \vert S \vert - 1 ) !}{k !} ( v ( S ⋃ \{ i \} ) - v ( S ) ) \qquad ( 2 )$$

Equation 2 illustrates a calculation of SHAP value. As shown in equation 2, if ϕ_{fi} is relatively small, it means omitting feature fᵢ may have a relatively small effect on v. Hence, it cannot be strongly correlated with any of features fₑₛ, as omitting any of fₑₛ would have a strong effect on v. This equation 2 may further show that if two features have a strong correlation effect, they would have a relatively high local importance score. This is because changing one or both of their values (i.e., in effect breaking the correlation), would impact the anomaly score drastically. Therefore, the local importance score associated with other features [symbol] may be used to select the other features [symbol] as the most important subset of features to calculate the expectation surface for feature [symbol] which may take into consideration of the correlation effects between features.

In some embodiments, the feature selection engine 124 may select a number of other features to calculate the expectation surface for feature fₑₛ, for example, 1, 2, 3, 4, 5, 6, 7, 8, 9, 10, 11, 12, 13, 14, 15, 16, 17, 18, 19, 20. In some embodiments, the number of other features selected to calculate the expectation surface for feature fₑₛ may be any natural number between 1-100, 1-1000, 1-10000, 1-100000. In some embodiments, a given sample of 2, 3, 4, or 5 features may be selected to calculate the expectation surface for feature fₑₛ, as the anomaly scores may capture the effects originating from correlations between feature fₑₛ and other features [symbol] .

### Algorithm

The present disclosure provides examples of algorithms for computing an expectation surface. The following algorithm may compute one-dimensional expectation surfaces for iForest model. As mentioned above, The Isolation Forest algorithm is based on the isolation principle: it tries to separate data points from one another, by recursively and randomly splitting the dataset into two partitions along its features axes. The iForest model is trained using unsupervised learning based on the theory that if a point is an outlier, it will not be surrounded by many other points, and therefore it will be easier to isolate it from the rest of the dataset with random partitioning. The Isolation Forest algorithm uses the training set to build a series of isolation trees, which when combined form the Isolation Forest; each isolation tree is built upon a subset of the original data, randomly sampled. The splitting is performed along a random feature axis, using a random split value which lies between the minimum and maximum values for that feature amongst the data points in that partition. This split process is performed recursively until a single point has been isolated from the others. The number of splits required to isolate an outlier is likely to be much smaller than the one needed by a regular point, due to the lower density of points in the surrounding feature space. Isolation Forest leverages an ensemble of isolation trees, with anomalies exhibiting a closer distance to the root tree. The anomaly score can be derived from path length h (x) of a point x which is defined as the average number of splits required to isolate the point across all the trees in the forest.

As shown below, the computation of a one dimensional expectation surface for a single tree is defined in Algorithm 1, with aid of algorithms 2, 3 and 4.

Algorithm 1: One-dimensional ES algorithm

Data: trained iForest tree
sample with features f

| | |
|---|---|
| Result: | dictionary containing a mapping of each feature fᵢ to a one-dimensional |
| | expectation surface ES(fᵢ). |

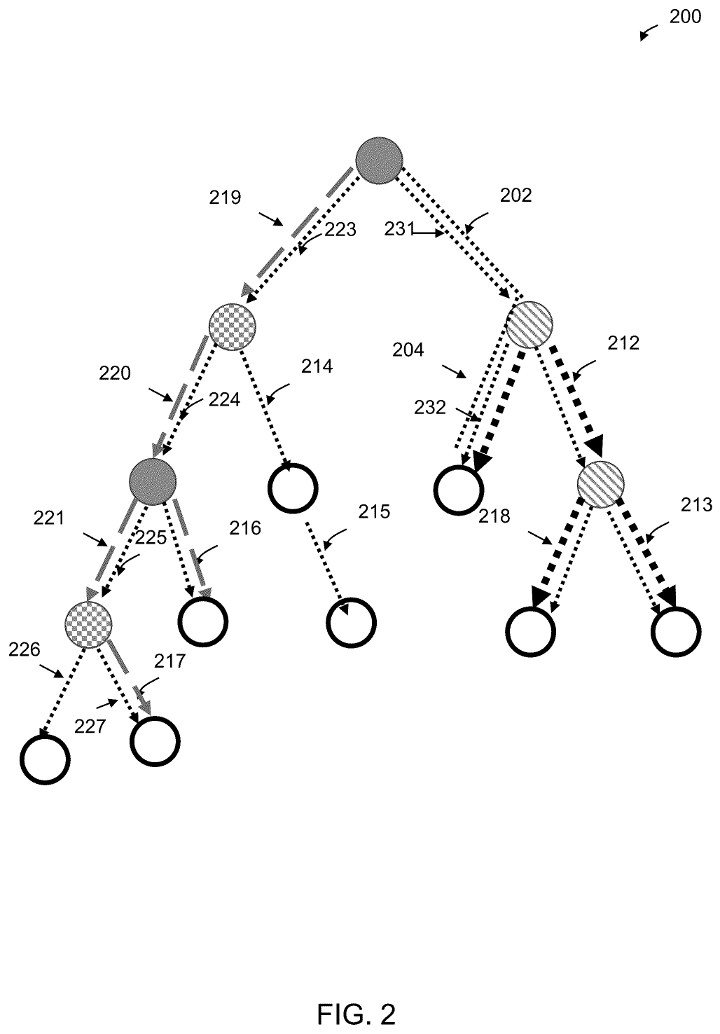

set queue q = {(rootNode, Ø, True, Ø)}
set expectation surface dictionary ES = { }
set actual path ranges dictionary p = {fᵢ = Øf or fᵢ ∈ f}
while q not empty do
| (Node, exploration feature, is actual path, range) q. pop( );
| if Node = Ø then
| | _ continue
| if exploration feature == Node.feature AND NOT is actual path
| then
| | /* This is case (1) in FIG. 2 */
| | q.push((Node.left, exploration feature, False,
| | range_update (range, Node.value, left)));
| | q.push((Node.right, exploration feature, False,
| | range_update(range, Node.value, right)))
| else if is actual path then
| | /* Dotted line 202, 204 in FIG. 2 */
| direction = actual path direction(Node, f);
| | /* follow normal path, but update range, as we could
| | explore that feature later */
| | p[Node. feature] < range_{update} (p[Node. feature], Node. value, direction)
| | q.push((actual (Node, f), Node. feature, True, Ø));
| | /* start a new exploration path */
| | q. pushrangeupdate (p[Node. feature], Node. value, ! direction)
| else
| | /* Case (2) in FIG. 2 */
| | q.push;
| if Node is leaf AND NOT is actual path then
| | ES[explorationfeature]. append (explorationfeature, valuerange, leaf depth)

Algorithm 2: Helper Algorithm to update the feature range

Input: current range of feature
value of split point of current node
direction, i.e. left vs right
Output: updated range
Function range_{update} (range, splitpoint, direction):
| if range = Øthen
| | range left, range right −∞, +∞
| else
| └ range left, range right ←range
| if direction == left then
| | range right ←split point;
| else
| └ range left ←split point
| range ← rangerange
| return range
End Function

Algorithm 3: Helper Algorithm to infer the direction of the actual path

Input: Current tree Node
feature values of scored sample
Output: the direction of the actual path
Function actual (Node, f):
| Feature value < Extractvalueof Node. featuref
| if featurevalue < Node. valuethen
| | return left;
| else
| └ return right;
End Function

Algorithm 4: Helper Algorithm to infer the child node
following the actual path

Input: Current tree Node
feature values of scored sample
Output: the child of Node that corresponds to the actual path
Function actual (Node, f):
| feature value ← ExtractvalueofNode. featuref
| if featurevalue < Node. valuethen
| |return Node.left;
| else
| └ return Node.right;
End Function

FIG. 2 demonstrates an example of implementing the algorithm to generate an expectation surface for a single tree structure, according to embodiments of the present disclosure. In some embodiments, the algorithm (e.g., Algorithm 1, 2, 3, and/or 4 as shown above) may be a modified breadth-first-search. It may distinguish the actual path from exploration paths. The actual path may represent the “normal” path through the tree based on the input features f. The actual path is represented by the dotted lines 202, 204 in FIG. 2. An exploration path of a feature fᵢ may represent paths through the tree that would occur for different values of fᵢ, while keeping the values of all other features fixed. Exploration paths may be represented by the paths (e.g., 219-220-221 (-227)/216; 223-214-215, 223-224-225-226/227; 231-232; 212-213; 212-218, etc.) corresponding to different features, in FIG. 2. In some embodiments, exploration paths can only be started from the actual path. In some embodiments, if the system is on an exploration path for feature fᵢ and if the system encounters another node of feature fᵢ, the system may explore both its children-hence try out all possible values of feature fᵢ, to calculate the expectation surface of feature fᵢ. If the system is on an exploration path for feature fᵢ and encounter a node of a feature fᵢ≠fᵢ, the system may traverse the tree normally-hence accounting for the fact that all other feature fᵢ≠fᵢ are kept fixed for the expectation surface of feature fᵢ. When the system encounters a leaf node, it may store the depth of the leaf (from which the anomaly score can be derived), for example, in the data storage 150 of the server platform 120 depicted in FIG. 1, and the value range that this path represents for the feature fᵢ. In some embodiments, as shown in Algorithm 1, with a single pass of Algorithm 1, the system may obtain all anomaly scores of all 1d expectation surfaces of the tree. In some embodiments, with a single pass of Algorithm 1, the system may obtain a subset of all anomaly scores of all 1d expectation surfaces of the tree.

### Higher Dimensional Generalizations

In some embodiments, algorithm 1 may provide generalizations to an expectation surface of higher dimension n (n>1). In some embodiment, an exploration path may allow n features to vary at the same time. That is, if a path is on an exploration path for a set of features fᵢ_{₁}, fᵢ_{₂}, . . . , fᵢ_{ₙ} (i.e., dimension of n), whenever a node of one of these features is encountered, both children nodes may be explored.

The following tables shows the different implementations of the algorithm to generate a one-dimensional expectation surface and an n-dimensional expectation surface.

| one dimensional | n dimensional |
|---|---|
| is actual path boolean & | dictionary e = {fᵢ: is_{exploring}∀fᵢ} denoting for |
| exploration feature | every feature if on an exploration path |
| ES dictionary keyed | ES dictionary keyed by n features |
| by one feature | |
| range is a single | range dictionary r = {fᵢ: (lower, upper)∀fᵢ} |
| number per node | denoting the value range of each feature on an |
| | exploration path |
| only one feature per | as long as \|e\| < n |
| exploration path | features can be added to the exploration path |
| | (else if condition in Algorithm 1) |

### Complexity Analysis

The algorithm provided herein may have improved scaling capability that it can be easily implemented with the number of samples N out of which the tree is grown. In the meantime, the algorithm herein may not significantly increase computational cost as proved by the algorithm complexity analysis below. In algorithm 1, there may be either one or two elements pushed into queue q. In some embodiments, the rate with which each case occurs may govern the algorithmic complexity of the algorithm. To derive the algorithmic complexity, the system described herein may consider one-dimensional expectation surfaces, with the assumption that the system is already on an exploration path for a feature fᵢ. The probability to encounter another node of the same type fᵢ may be equal to

$${P}_{e} = \frac{1}{K} ,$$

where K is the overall number of features. In some embodiments, for the number of node visits of a single tree of depth m, Sₘ, the following recursion relation (equation 3) may follow:

$${s}_{m} = {s}_{m - 1} ( 1 - \frac{1}{K} ) + 2 {s}_{m - 1} \frac{1}{K} + 1 \qquad ( 3 )$$

In some embodiments, the first summand corresponds to the scenario of encountering a node that is node of feature type fᵢ, which may happen with a probability

$$1 - \frac{1}{K} .$$

In this case, there may only be a single element pushed to the queue q. If the system encounters the feature fᵢ, it may push two elements to the queue q, which explains the second summand. The third summand may account for having visited the root node.

The above recursion relation of equation 3 may be solved as follows:

$${s}_{m} = {s}_{m - 1} ( 1 + \frac{1}{K} ) + 1 = 1 + ( 1 + \frac{1}{K} ) [ 1 + ( 1 + \frac{1}{K} ) {s}_{m - 2} + … ] \qquad ( 4 )$$

$$1 + ( 1 + \frac{1}{K} ) + {( 1 + \frac{1}{K} )}^{2} {s}_{m - 2}$$

$${\sum }_{{m}^{1} = 0}^{m - 1} {( 1 + \frac{1}{K} )}^{{m}^{1}}$$

$$\frac{1 - {( 1 + \frac{1}{K} )}^{m}}{1 - ( 1 + \frac{1}{K} )}$$

$$K [ {( 1 + \frac{1}{K} )}^{m} - 1 ]$$

In some embodiments, if the system is not on an exploration path, the recursion relation of the total number of visited nodes cₘ of a tree of depth m may be the following:

$${c}_{m} = {c}_{m - 1} + {s}_{m - 1} + 1 \qquad ( 5 )$$

In some embodiments, the first summand of equation 5 may represent the case for which an element of the actual path is added to the queue q. The second summand may correspond to the case of starting a new exploration path. The third summand may account for having visited the root node. Equation 5 may be solved as follows

$${c}_{m} = {c}_{m - 2} + {s}_{m - 1} + {s}_{m - 2} + 2 \qquad ( 6 )$$

$${s}_{m - 1} + {s}_{m - 2} + … + {s}_{1} + {c}_{1} + m - 1$$

$$K [ {\sum }_{{m}^{1} = 1}^{m - 1} {( 1 + \frac{1}{K} )}^{{m}^{1}} - ( m - 1 ) ] + m$$

$${K}^{2} [ {( 1 + \frac{1}{K} )}^{m} - 1 - \frac{m}{K} ] + m$$

$$K ≫ {1}_{\to } \frac{m ( m + 1 )}{2} + \frac{{m}^{3}}{6} \frac{1}{K} \qquad ( 7 )$$

In some embodiments, for a tree grown out of N samples, the average height of a trained tree is m=log N. It hence follows that for K>>1, the number of nodes visited and hence the algorithmic complexity scales as follows:

$${{c}_{m} ( log N )}^{2} \qquad ( 8 )$$

In some embodiments, the algorithmic complexity of a ‘normal’ iForest inference may be log N. The expectation surface algorithm provided herein is hence not more expensive, and has still excellent scaling behavior with the number of samples N out of which the tree is grown.

In some embodiments, for a d-dimensional expectation surface, the recursion relation for Sₘ may be the following:

$${s}_{m} ( d ) = {s}_{m - 1} ( d ) ( 1 - \frac{d}{K} ) + 2 {s}_{m - 1} \frac{d}{K} + 1 \qquad ( 9 )$$

$$\frac{1 - {( 1 + \frac{d}{K} )}^{m}}{1 - ( 1 + \frac{d}{K} )} \qquad ( 10 )$$

$$\frac{K}{d} [ {( 1 + \frac{d}{K} )}^{m} - 1 ] \qquad ( 11 )$$

In some embodiments, for a 2-dimensional expectation surface, the recursion relation of cₘ may be the following:

$${c}_{m} ( d ) = {c}_{m - 1} ( d ) + {s}_{m - 1} ( d - 1 ) + 1 \qquad ( 12 )$$

$${c}_{m - 2} ( d ) + {s}_{m - 1} ( d - 1 ) + {s}_{m - 2} ( d - 1 ) + 2 = m + {\sum }_{{m}^{′} = 1}^{m - 1} {s}_{{m}^{′} ( d - 1 )} = m + \frac{{K}^{2}}{{d}^{2}} [ ( 1 + \frac{d}{K} ) m - 1 - m \frac{d}{K} ]$$

$$K ≫ d \frac{m ( m + 1 )}{2} + \frac{{m}^{3}}{6} \frac{d}{K} \qquad ( 13 )$$

In some embodiments, the first order approximation, for K>>d, of the runtime complexity may be follows:

$${{c}_{m} ( log N )}^{2} \qquad ( 14 )$$

In some embodiments, the memory requirement is dominated by the ES dictionary. In some embodiments, for every leaf node that the system encounters, it may add one entry into ES dictionary. In some embodiments, the number of leaf nodes may be less than the number of overall visited nodes. Therefore, if d>>K, the memory complexity [symbol] is bound as:

$${( log N )}^{2} \qquad ( 15 )$$

In some embodiments, [symbol] and [symbol] may be the number of leaf nodes encountered by the algorithm for a tree of depth m, which may continue exact derivation.

### Use Case

The anomaly detection methods and systems as described herein can be applied in a wide range of industries and fields. In some cases, the methods and systems may be implemented on a cloud platform system (e.g., including a server or serverless) that is in communication with one or more user systems/devices via a network. The cloud platform system may be configured to provide the aforementioned functionalities to the users via one or more user interface. The user interface may comprise a graphical user interfaces (GUIs), which may include, without limitation, web-based GUIs, client-side GUIs, or any other GUI as described elsewhere herein.

A graphical user interface (GUI) is a type of interface that allows users to interact with electronic devices through graphical icons and visual indicators such as secondary notation, as opposed to text-based interfaces, typed command labels or text navigation. The actions in a GUI are usually performed through direct manipulation of the graphical elements. In addition to computers, GUIs can be rendered in hand-held devices such as mobile devices, MP3 players, portable media players, gaming devices and smaller household, office and industry equipment. The GUIs may be provided in a software, a software application, a web browser, etc. The GUIs may be displayed on a user device or user system (e.g., mobile device, personal computers, personal digital assistants, cloud computing system, etc.). The GUIs may be provided through a mobile application or web application.

In some cases, the graphical user interface (GUI) or user interface may be provided on a display. The display may or may not be a touchscreen. The display may be a light-emitting diode (LED) screen, organic light-emitting diode (OLED) screen, liquid crystal display (LCD) screen, plasma screen, or any other type of screen.

In some cases, one or more systems or components of the system (e.g., anomaly detection, explanation generation, explanation visualization, etc.) may be implemented as a containerized application (e.g., application container or service containers). The application container may provide tooling for applications and batch processing, such as web servers with Python or Ruby, JVMs, or even Hadoop or HPC tooling. For instance, the frontend of the system may be implemented as a web application using the framework (e.g., Django Python) hosted on an Elastic Cloud Compute (EC2) instance on Amazon Web Services (AWS). The backend of the system may be implemented as serverless compute service such as hosted on AWS Lambda as a serverless compute service running a web framework for developing RESTful APIs (e.g., FastAPI). This may beneficially allow for a large-scale implementation of the system.

In some cases, one or more functions or operations consist with the methods described herein can be provided as software application that can be deployed as a cloud service, such as in a web services model. A cloud-computing resource may be a physical or virtual computing resource (e.g., virtual machine). In some embodiments, the cloud-computing resource is a storage resource (e.g., Storage Area Network (SAN), Network File System (NFS), or Amazon S3.RTM.), a network resource (e.g., firewall, load-balancer, or proxy server), an internal private resource, an external private resource, a secure public resource, an infrastructure-as-a-service (IaaS) resource, a platform-as-a-service (PaaS) resource, or a software-as-a-service (SaaS) resource. Hence, in some embodiments, a cloud-computing service provided may comprise an laaS, PaaS, or SaaS provided by private or commercial (e.g., public) cloud service providers.

Methods and systems herein may be integrated in any third-party systems in a user selected deployment option such as SaaS or alternative deployment options, based on a cloud-native, secure software stack. For example, the anomaly detection and/or GUI modules that can be deployed to interface with one or more banks with one or more different bank cores or banking platforms such as Jack Henry™, FIS™, Fiserv™, or Finxact™, although not limited thereto. In some cases, depending on the use application, the system herein may comprise logging and telemetry module to communicate a security system of a bank infrastructure which can provide detailed bank-facing technical operations and information security details, giving the banks visibility and auditability the bank may need.

In an exemplary application of the presented anomaly detection system in transaction monitoring and Anti-money laundering (AML) monitoring, the false positives may be reduced significantly (e.g., over 70%) to prevent increased compliance headcount and unknown crime patterns can be detected before they become rampant.

Existing anomaly detection methods in AML monitoring may only provide insights into the features that lead to an anomaly but don't give insight into what would have constituted a normal value. For example, the following examples are generated using existing local feature importance algorithm in a transaction monitoring system:

The transaction is anomalous due to the factors shown below:

The volume of transactions against this same
counterparty in the last 30 days vs. the overall
volume of non-authorization transactions was 11.00%
The count of transactions against this same
counterparty in the last 30 days vs. the overall
count of non-authorization transactions was 5.20%
The volume of nighttime transactions in the
last 30 days vs. the overall volume of captured
and non-declined transactions was 40.32%

This type of explanations may help a user to understand what the main factors are (i.e., features) that drives the detection/determination of anomaly. It may inform the user the actual values of the features (e.g., 11%, 5.20%, 40.32% in above example), but it may lack information about what a normal value would have been. Additionally, it doesn't provide information about the direction of the outlies outside of the normal value range, i.e. the user may have to guess whether the reported value of 11% cash accumulation against a single counterparty is a too high or a too low value according to the model. This becomes exacerbated across difference industries, for example, some accounts a value of 11% might be normal, for instance, for a merchant selling rare and expensive paintings, while for other accounts this would be an anomaly, like for a bakery.

The improved anomaly detection methods and systems herein may beneficially provide the expected values in the context of the given transaction. In some embodiments, system herein May allow users to visualize with the anomaly detection analytics via streamlined and intuitive GUI. For example, users may be provided with not only the detected anomalous transaction, the attributes/factors led to the conclusion but also the expected unsuspicious range value for each factor. The GUI may provide guidance to a user (e.g., investigators, regulators, and law enforcement people, etc) an assessment of the attributes, severity, and tendencies of the suspicious activities. In another example, the GUI may also provide an interactive tool allowing users to interact with a visualization of the multiple factors/features and visualize how the features are correlated. Examples and details about the GUIs are described later herein.

FIG. 3a and FIG. 3b illustrate an example use case of providing explanations to an output of AI algorithm by utilizing expectation surfaces, according to some embodiments of the present disclosure. As described elsewhere herein, an explainable AI is highly desired in the financial industry, and in the context of Anti-money laundering (AML) monitoring, as it facilitates trust, efficiency, and precludes regulatory impediments. In some embodiments, the feature selection engine 124 may be configured to receive a stream of data representing financial transactions (e.g., financial transaction logs). Financial transaction logs data may comprise, without limitation, transaction amount, transaction currency (e.g., U.S. Dollar, Euro, Japanese Yen, Great British Pound, Australian Dollar, Canadian Dollar, etc.), transaction type name (e.g., wire activities, cash deposit activities, regular check, cashier's check, certified check, money order, etc.), transaction time (e.g., time of a day, day of a year/a quarter, etc.), transaction unique identification number, and the like.

Transactions may be monitored and assigned with a money-laundering risk score. In some embodiments, this money-laundering risk score may be generated by IForest model. In some embodiment, this money-laundering risk score may be generated based on the financial transaction logs data associated with financial transaction logs. For example, the further a transaction (or a group of transactions) does not conform to the normal profile, the higher a risk score may be associated to the transaction. In some embodiments, a risk score is assigned to a group of financial transactions associated with one entity, e.g., a bakery, a restaurant, a bookstore, a car dealer etc. In some embodiments, a risk score is assigned to a group of financial transactions associated with one entity during a period of time, e.g., an hour, a few hours, a day, a week, two weeks, three weeks, a month, a quarter, a year, a few years, etc. As described elsewhere herein, a risk score may denote an outlier that does not conform to the normal profile of the transaction in context of the industry the transaction is in. If a risk score of a transaction or a group of transactions is greater than a pre-determined threshold, expectation surface generation engine 126, explanation generation module 128, or other components of the server platform 120 may mark the underlying transaction(s) as an anomaly. In some embodiments, this pre-determined threshold may be determined by an administration agent, such as the administration agent 110. In some embodiments, this pre-determined threshold may be determined by a Machine Learning model, which has been trained to understand the normal profile in different industries or for different business models. Examples of different industries may comprise, without limitation, restaurants, car dealers, bookstores, software companies, etc. Examples of business models may comprise, without limitation, retailers, distributions, wholesales, manufactures, designer, service providers, etc.

The feature selection engine be configured to select features to calculate expectation surface based on feature properties associated with individual features of the anomalous transactions. In some embodiments, the features selection engine may select features to calculate the expectation surface for all transactions, whether anomalous or not. The expectation surface may provide what the above examples are missing: the expected value range of the model in the context of the transaction. From those expectation surfaces, the expected value of a feature may be derived, under the assumption that all other features are not changed (i.e. the context of the transaction is not changed).

FIG. 3C shows an example of an output of the system utilizing expectation surfaces. The explanation in the example may be generated by a one-dimensional expectation surface as described elsewhere herein. The GUI may display, for example,

The transaction is anomalous due to the factors shown below:

The volume of transactions against this same counterparty in the last 30 days vs. the overall volume of non-authorization transactions was 11.00%. The expected range of values for unsuspicious transactions would have been 0%-5%.

The count of transactions against this same counterparty in the last 30 days vs. the overall count of non-authorization transactions was 5.20%. The expected range of values for unsuspicious transactions would have been 0%-2.1%.

The volume of nighttime transactions in the last 30 days vs. the overall volume of captured and non-declined transactions was 40.32%. The expected range of values for unsuspicious transactions would have been 0%-10.1%.

In the illustrated example, the expected unsuspicious range is provided, e.g., 0%-5%; 0%-2.1%; 0%-10.1%. The expected unsuspicious value range may provide guidance to a user (investigators, regulators, and law enforcement people, etc) an assessment of the attributes, severity, and tendencies of the suspicious activities. Such explanation beneficially facilitates efficiency and trust of the AI algorithms for AML regime. The expected value of a feature may be derived using the algorithm as described above under the assumption that all other features are not changed (i.e., the context of the transaction is not changed).

In some embodiments, higher dimensional expectation surfaces may be used as an interactive tool for investigators to understand the correlation between features. FIG. 3A illustrates an expectation surface for business type 1 and a set of transaction data points. As depicted in FIG. 3A, the relative amount of nighttime transactions is shown against the monthly revenue of a restaurant. The contour plot 302 denotes the model expectation surface of a higher-dimensionality (e.g., 2D, 3D, 4D, 5D, etc.), derived using the expectation surface algorithm. Darker contour regions may denote a high likelihood of the expected values, and lighter contour regions denote a low likelihood of the expected values. In the illustrated example, the model has been trained to learn that there is a correlation between the revenue and the number of nighttime transactions of a restaurant (as people tend to leave more money at a restaurant during the night, as opposed to, for instance, the lunch break). The solid dots 305 denote the actual datapoints of an anomalous restaurant account. The plot conveys not only that the correlation between nighttime transactions and revenue is reversed for this anomalous account, but also that in general the account behaves unusual as most of the dots are outside of the expectation surface 302.

In some cases, upon identifying an anomalous account (e.g., anomalous restaurant account), the method may compare the anomalous restaurant account with an expectation surface of another type of business (e.g., Automotive Store). If there is a match, it may indicate the account may be disguising itself as a Restaurant which is suspicious.

FIG. 3B illustrates an expectation surface for business type 1 (e.g., restaurant) and an expectation surface for business type 2 (e.g., Automotive store), and a set of transaction data points. In some embodiments, business type 1 is different than business type 2. In some embodiments, business type may be defined as for different industries, such as restaurants, car dealers, bookstores, software companies, etc. In some embodiments, business type may be defined as for different business models, such as retailers, distributions, wholesales, manufactures, designer, service providers, etc. As depicted in FIG. 3B, an expectation surface 302 for a restaurant is shown, wherein the darker contour regions may denote a high likelihood of the expected values, and lighter contour regions denote a low likelihood of the expected values. Additionally, an expectation surface 304 for an automotive store is shown, wherein the darker contour regions may denote a high likelihood of the expected values, and lighter contour regions denote a low likelihood of the expected values. The solid data points representing the actual transactions falls mostly within the expectation surface 304. Therefore, if these solid data points are for transactions of an automotive store, then they are normal transactions. However, if these solid data points are for transactions of a restaurant, then they are likely to be an anomaly because they do not fit in the expectation surface 302 for a restaurant.

The GUI may allow users to visualize the explanation and anomaly detection analytics in an interactive manner. Visualizations as in FIGS. 3A and 3B may be used in a transaction monitoring software, for example, via a user interface (UI). In some embodiments, these visualizations may be deployed in an interactive way. For instance, a user (e.g., investigator) may select the features of the expectation surface to plot on the x and y axes. This may provide further insights into the nature of the anomaly, giving detailed feedback about the expected value (or value range) of a correlated pair of features. For example, Anti-money laundering (AML) detection module of the system may further contrasting/comparing expectation surfaces of different types of accounts (i.e., across different types of businesses) to uncover suspicious behaviors.

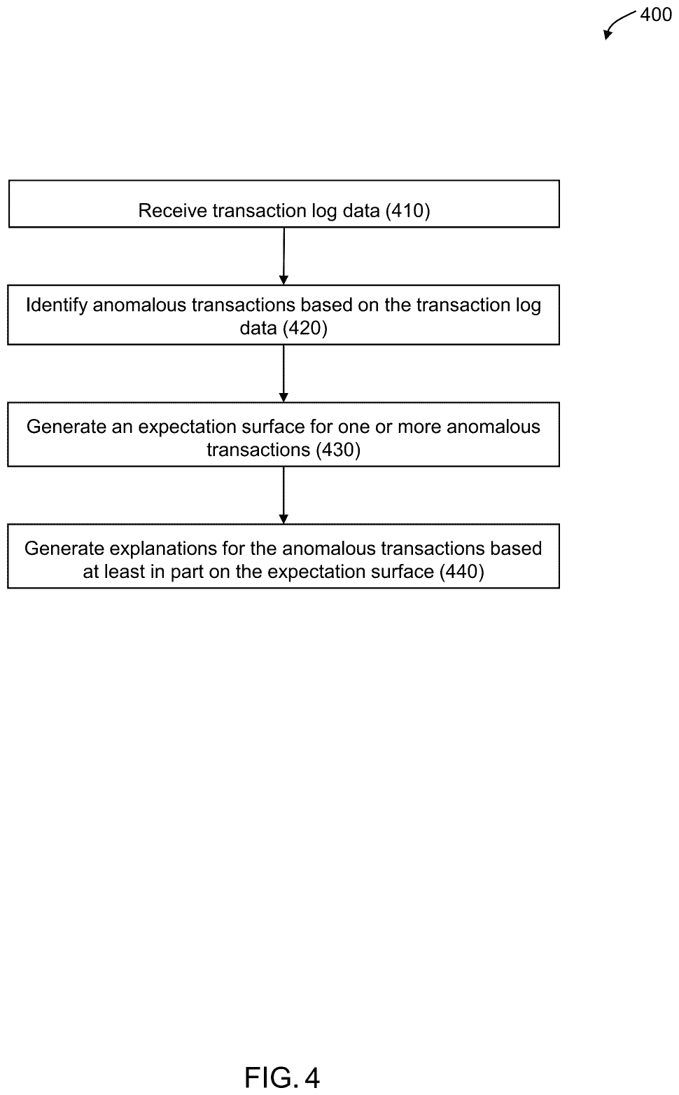

FIG. 4 is a flow diagram depicting an example process 400 for providing explanations for outputs of an AI algorithm for financial transactions, according to one embodiment. As depicted in FIG. 4, once the platforms and systems of the present disclosure is initialized, the process 200 begins with operation 410, where the system 400 collects transaction log data. In some embodiments, financial transaction logs data may comprise, without limitation, transaction amount, transaction currency (e.g., U.S. Dollar, Euro, Japanese Yen, Great British Pound, Australian Dollar, Canadian Dollar, etc.), transaction type name (e.g., wire activities, cash deposit activities, regular check, cashier's check, certified check, money order, etc.), transaction time (e.g., time of a day, day of a year/a quarter, etc.), transaction unique identification number, and the like.

The process 400 may then proceed to operation 420, wherein the system 100 may identify anomalous transactions based, at least in part, on the transaction log data. In some embodiments, transactions may be monitored and assigned with a risk score (e.g., money-laundering risk score). In some embodiments, this money-laundering risk score may be generated by IForest model. In some embodiment, this money-laundering risk score may be generated based on the financial transaction logs data associated with financial transaction logs. For example, the further a transaction (or a group of transactions) does not conform to the normal profile, the higher a risk score may be associated to the transaction. In some embodiments, a risk score is assigned to a group of financial transactions associated with one entity, e.g., a bakery, a restaurant, a bookstore, a car dealer etc. In some embodiments, a risk score is assigned to a group of financial transactions associated with one entity during a period of time, e.g., an hour, a few hours, a day, a week, two weeks, three weeks, a month, a quarter, a year, a few years, etc. As described elsewhere herein, a risk score may denote an outlier that does not conform to the normal profile of the transaction in context of the industry the transaction is in. If a risk score of a transaction or a group of transactions is greater than a pre-determined threshold, feature selection engine 124 of the system may mark the underlying transaction(s) as an anomaly. In some embodiments, this pre-determined threshold may be determined by an administration agent, such as the administration agent 110. In some embodiments, this pre-determined threshold may be determined by a Machine Learning model, which has been trained to understand the normal profile in different industries or for different business models. Examples of different industries may comprise, without limitation, restaurants, car dealers, bookstores, software companies, etc. Examples of business models may comprise, without limitation, retailers, distributions, wholesales, manufactures, designer, service providers, etc.

Next, the process 400 may continue to operation 430, where the system 100 may generate an expectation surface which is an inverted anomaly score surface of a selected subset of features. The expectation surface may be generated to provide explanation for marking the one or more anomalous transactions. The feature selection engine 124 may select a subset of features to calculate the expectation surface based on feature properties associated with individual features of the anomalous transactions. In some embodiments, the features selection engine 124 may select features to calculate the expectation surface for all transactions, whether anomalous or not. In some embodiments, the expectation surface generation engine 126 of the server platform 120 may generate an expectation surface for the transactions, for example, based on the selected features.

An expectation surface may be generated, in operation 430, as an inverted anomaly score surface of a given subset of features, e.g., feature fₑₛ. The computation of the expectation surface is same as described above. The expectation surface may indicate the normal profile associated with a transaction or a group of transactions. For example, as shown in connection with FIG. 3A and FIG. 3B, an expectation surface may indicate the normal profile associated with transactions in restaurant industry or in an automotive store industry. In some embodiments, the expectation surface may be closely related to the type of business from which the transaction is originated. Examples of different industries may comprise, without limitation, restaurants, car dealers, bookstores, software companies, etc. Examples of business models may comprise, without limitation, retailers, distributions, wholesales, manufactures, designer, service providers, etc. Transactions in different types of business may have different expected ranges that considered as normal. For example, for a car dealer, the transaction amount may be a relative high number as cars generally are priced higher than a thousand dollars. The transaction frequency for a car dealer, though, may be lower than a grocery store. These traits may be shown by the expectation surface associated with a particular type of business and may be utilized to identify the reasons and explanations as to why some transactions are marked as outliers or anomaly.

Next, the process 400 may proceed to operation 440, wherein the system 100 may provide explanations for the anomalous transactions based at least in part on the expectation surface. The explanation generation module 128 of server platform 120 may generate explanations for the anomalous transactions based at least in part on the expectation surface. In some embodiments, the expectation surface may provide an expected value range for difference features or factors. For example, the expectation surface may indicate: for a bakery store, it is normal to have 68-85% revenue generated during morning hours, such as between 6:00 AM to 11:00 AM. When a large number of transactions (e.g., 90%) for a bakery fall outside of this expected range provided by the expectation surface, the transactions may be marked as anomaly. In some embodiments, the explanation generation module 128 of the server platform 120 may utilize, in operation 440, this expectation surface to provide explanations as to the reasons a transaction or a group of transactions are anomalous. For example, for the above example, the explanation generation module 128 may provide explanations such as: 90% of the transactions occurs outside of the expected time period of 6:00 AM to 11:00 AM. In another example explanation, the explanation generation module 128 may provide, in operation 440, explanations such as: only 10% of the transactions occurs outside of the expected time period 6:00 AM to 11:00 AM, normally, it should be 68-85%. This may provide the information receivers, (e.g., investigators, regulators, and law enforcement people, etc.) with insights why these transactions are marked anomalous, so as to facilitate investigation activities. In some embodiments, in operation 440, natural language processing (NLP) to generate human-comprehensible explanations. NLP may be a subfield of linguistics, computer science, and artificial intelligence concerned with the interactions between computers and human language. Other mechanisms may be utilized in operation 440 to generate human-comprehensible explanations.

Optionally, the method may further comprise comparing the expectation surface of one types of business to the expectation surfaces of other types of business to determine a money-laundering activity. The comparison result may be displayed to the user on the GUI to guide a user in further assessment.

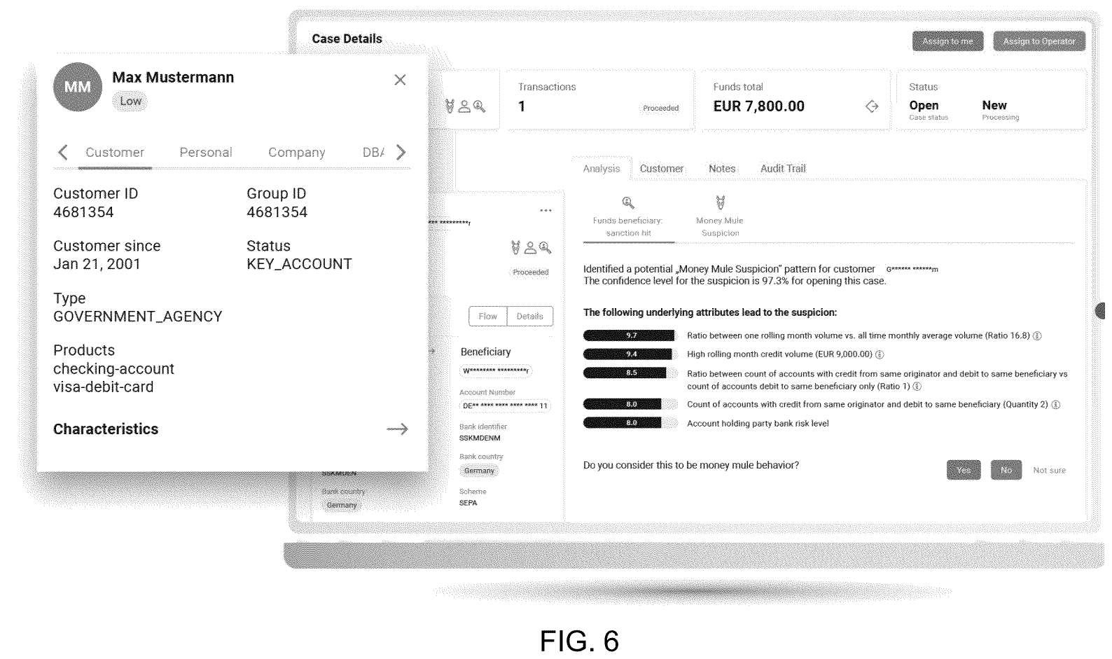

FIGS. 6-9 show various examples of GUI provided by the methods and systems herein for fraud detection and transaction monitoring. The anomaly detection methods herein may be implemented in for detecting and preventing fraud in real-time. For example, the system may be capable of providing accurate fraud detection in environments where limited data is available while simultaneously reducing false positive alerts. The input data packet may be transaction data and optionally augmented by non-monetary data such as IP address, device ID and other streaming data. In some cases, pre-processing of transaction data may be conducted to create an input feature set of k dimensionality. The pre-processing may comprise, for example, feature engineering to form the feature space (e.g., features related to accounts such as account number, account type, data of account opening, data of the last transaction, balance available, features related to transactions such as transaction reference number, account number, type of transaction, currency of transaction, timestamp of transaction, terminal reference number, etc.), normalization (e.g., transform features to be on a similar scale), or segmentation, etc. may be employed.

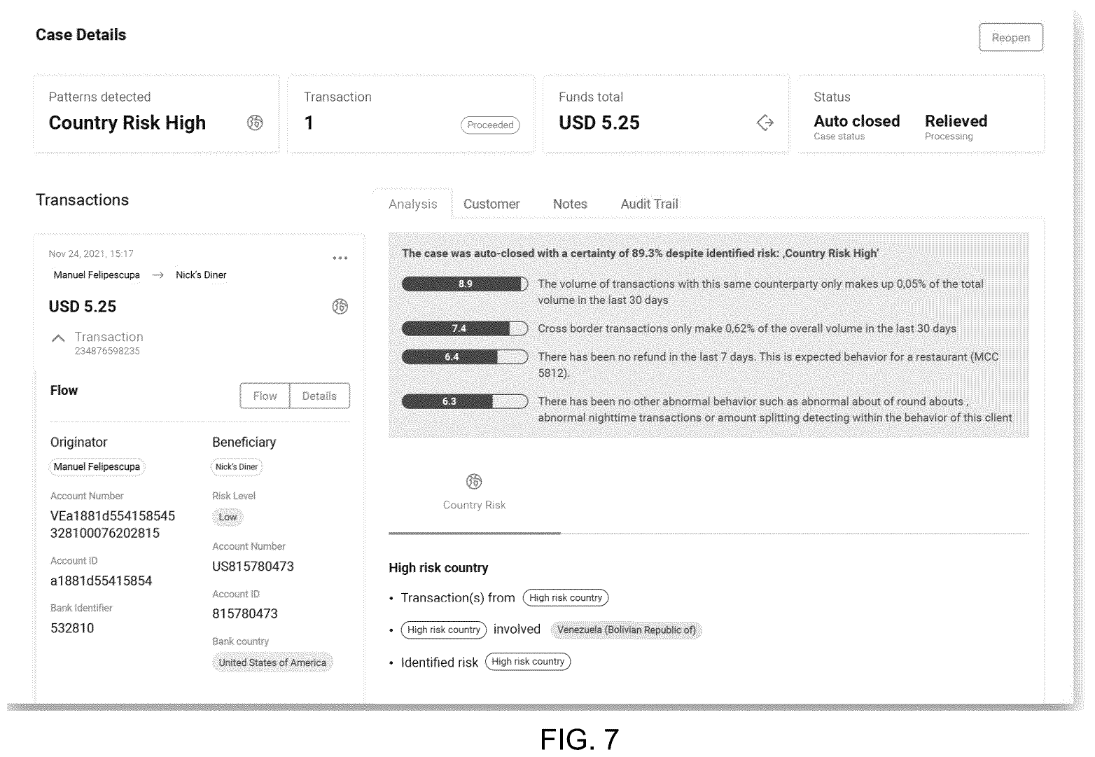

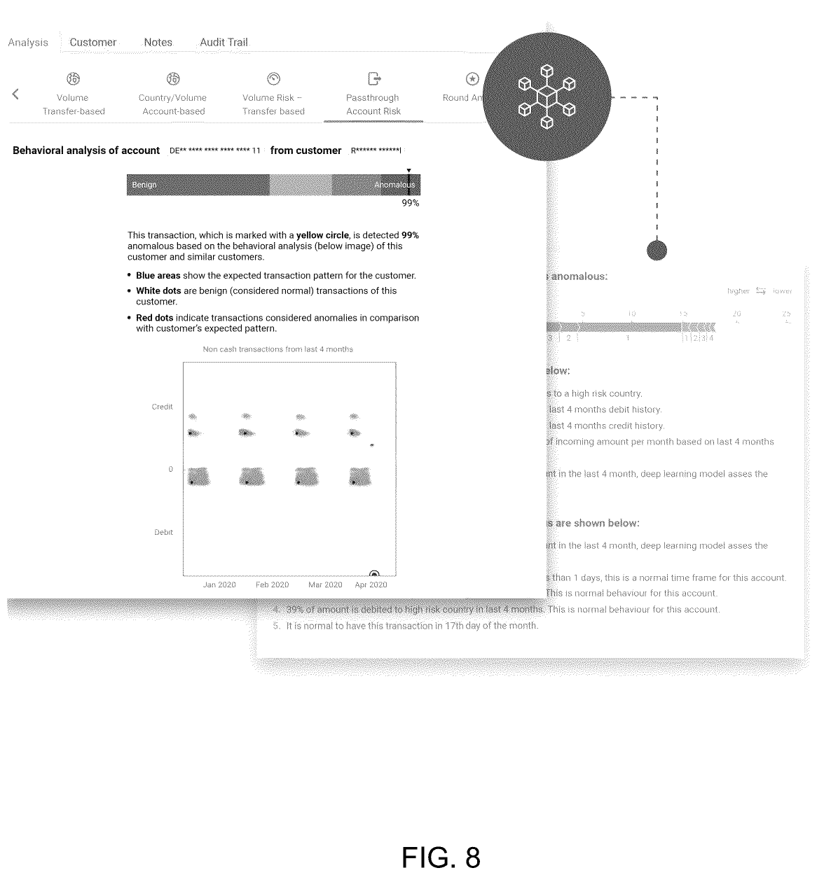

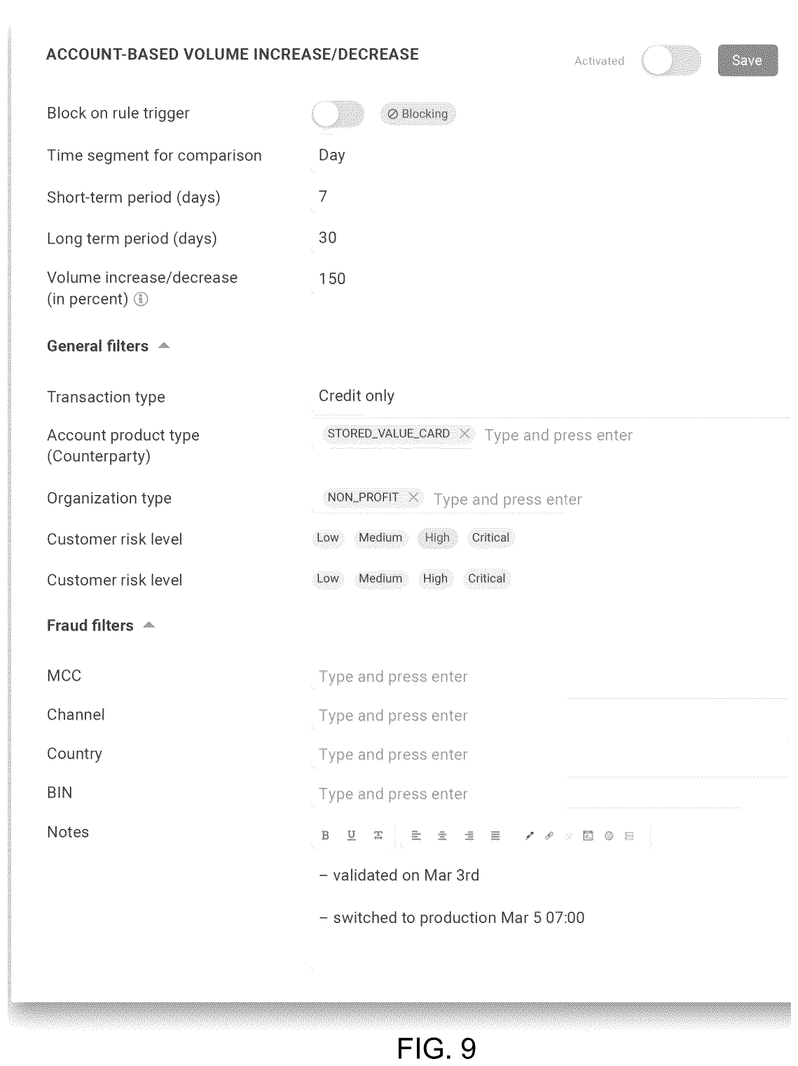

FIG. 6 shows an example of GUI providing transparent data in natural language, augmented by graphical explanations of AI models output and risk indicators in a streamlined interface. FIG. 7 shows an example of GUI for blocking transactions in real-time and allowing real-time response from customers and analysts to ensure customers and analysts are fully informed instantly. The feedback received via the GUI is utilized to constantly retrain the AI models along with cross-institutional learnings to further improve the model for understanding normal customer behavior and effectively identifying falsely alerted cases. FIG. 8 shows an example of GUI for providing behavioral analytics of customer behavior. The system may generate deviations on all data points, finding unknown events pointing to suspected fraud, detect and prevent new, emerging fraud patterns to stop payments in real time. The backend system (e.g., iForest model and explanation generation module) may beneficially allow for learning customer transaction patterns, detection of fraud without the need for fixed thresholds, and provide explanations so an operator can further determine the learned pattern is reasonable. FIG. 9 shows an example of GUI for self-service configuration of one or more parameters of the system. The GUI may allow users to fine-tune the algorithm and conduct what-if analyses based on real data in a sandbox, committing changes only when the new rules/parameters are ready.

### Computer Systems

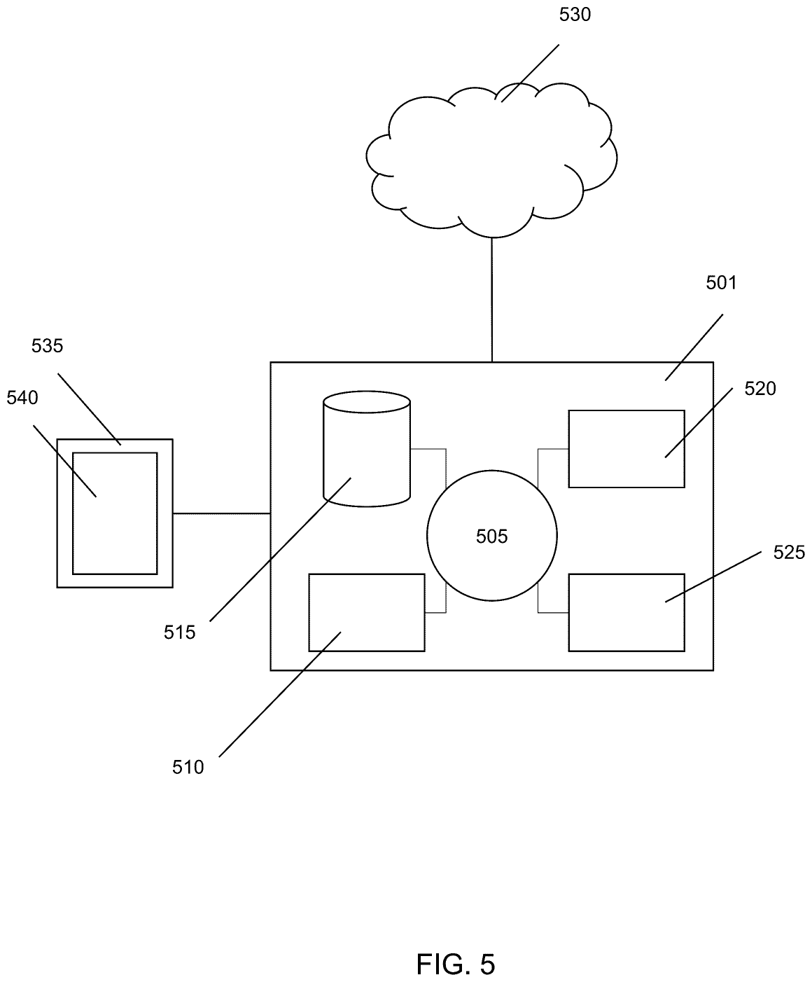

The present disclosure provides computer systems that are programmed to implement methods of the disclosure. FIG. 5 shows a computer system 501 that is programmed or otherwise configured to provide explanations for AL algorithms. The computer system 501 can regulate various aspects of the present disclosure. The computer system 501 can be an electronic device of a user or a computer system that is remotely located with respect to the electronic device. The electronic device can be a mobile electronic device.

The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 505.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A computer-implemented method for providing explainable anomaly detection, comprising:
(a) generating a set of input features by processing an input data packet related to one or more transactions;
(b) predicting, using a model trained using a machine learning algorithm, an anomaly score for each of the one or more transactions by processing the set of input features;
(c) computing an expectation surface for at least subset of features from the set of input features; and
(d) generating, based at least in part on the expectation surface, an output comprising i) a detection of an anomalous transaction from the one or more transactions, ii) one or more factors attributed to the anomalous transaction and iii) an expected value range for the one or more factors.

2. The computer-implemented method of claim 1, wherein the model does not provide explanation of a prediction and wherein the machine learning algorithm is unsupervised learning.

3. The computer-implemented method of claim 1, wherein the model is an isolation forest model.

4. The computer-implemented method of claim 3, wherein the expectation surface is a one-dimensional surface and wherein the expectation surface is computed by traversing a tree of the isolation forest model.

5. The computer-implemented method of claim 3, wherein the expectation surface is a surface of n dimensionality and wherein the expectation surface is computed by distinguishing an actual path from an exploration path.

6. The computer-implemented method of claim 5, wherein the exploration path allows n features to vary at the same time.

7. The computer-implemented method of claim 1, wherein the expectation surface has a dimensionality same as the number of the subset of features.

8. The computer-implemented method of claim 1, wherein the expectation surface is an inverted anomaly score surface of the subset of features.

9. The computer-implemented method of claim 1, wherein the at least subset of features is selected using a local feature importance algorithm.

10. The computer-implemented method of claim 1, wherein the anomalous transaction is a fraudulent activity.

11. The computer-implemented method of claim 10, further comprising comparing the expectation surface with one or more expectation surfaces of one or more other types of business.

12. The computer-implemented method of claim 10, further comprising determining a money laundering activity upon finding a match of the expectation surface with the one or more expectation surfaces.

13. A system for providing explainable anomaly detection, comprising:
a first module comprising a model trained to predict an anomaly score for each of one or more transactions, wherein an input to the model includes a set of input features related to the one or more transactions;
a second module configured to compute an expectation surface for at least a subset of features from the set of input features; and
a graphical user interface (GUI) configured to display information based at least in part on the expectation surface, i) a detection of an anomalous transaction from the one or more transactions,
ii) one or more factors attributed to the anomalous transaction and iii) an expected value range for the one or more factors.

14. The system of claim 13, wherein the model does not provide explanation of a prediction and is trained using unsupervised learning.

15. The system of claim 13, wherein the model is an isolation forest model.

16. The system of claim 15, wherein the expectation surface is a one-dimensional surface and wherein the expectation surface is computed by traversing a tree of the isolation forest model.

17. The system of claim 15, wherein the expectation surface is a surface of n dimensionality and wherein the expectation surface is computed by distinguishing an actual path from an exploration path.

18. The system of claim 17, wherein the exploration path allows n features to vary at the same time.

19. The system of claim 13, wherein the expectation surface has a dimensionality same as the number of the subset of feature.

20. The system of claim 13, wherein the expectation surface is an inverted anomaly score surface of the subset of features.
